(19) United States
(12) Patent Application Publication
(10) Pub. No.: US 2012/0027895 A1
(43) Pub. Date: Feb. 2, 2012

(54) DESSERT AND METHOD OF MAKING SAME

(76) Inventor: Larry A. Bach, Winter Park, FL (US)

(21) Appl. No.: 12/845,577

(22) Filed: Jul. 28, 2010

(51) Int. Cl. A23G 3/56; A23G 3/54; B65D 85/60

(52) U.S. Cl. 426/110; 426/394; 426/115

(57) ABSTRACT

A dessert and method of making same is disclosed. In a particular embodiment, the method includes stuffing a first layer of dessert material into a bottom of a container, adding a first layer of filling or icing on top of the first layer of dessert material, stuffing a second layer of dessert material on top of the first layer of filling or icing, and adding a second layer of filing or icing on top of the second layer of dessert material, where the container is adapted to push the dessert out of a top end of the container to sequentially reveal each layer of dessert material and layer of filling or icing for consumption. Each layer of dessert material may be formed to approximately a same width as the container before stuffing into the container.

### I. FIELD

The present disclosure is generally related to a dessert and method of making same.

### II. DESCRIPTION OF RELATED ART

Cake is a form of food, typically a sweet, baked dessert. Cakes are most often made with a combination of most, but not necessarily all, of the following ingredients: flour, sugar, eggs, fat (butter or otherwise), water, flavoring, and leavening agents such as baking powder or yeast. Most cakes are baked but some are not. Due to religious, dietary, or health restrictions, some or many of the above ingredients may be left out or substituted for, with other ingredients. In addition, some versions of cakes may be vegan as well as gluten free versions.

Most often, when thinking of a cake, we think of a layer cake which includes two additional elements beside the actual cake layers. These are a layer or layers of filling, and an icing on the outside of the cake. There are many types of filings that may include fruit flavored jam types, custards, mousse of all flavors, ganache, nuts, whipped toppings, whipped cream, meringues, and all flavors of butter creams and icings. The icing on the outside also has many variations.

An inherent problem with a layer cake is its size and portability. Most often you have to buy a whole one. Even “small” cakes or half cakes, have many servings. If a customer purchases a slice of cake, then, it lacks portability. If the slice is not wrapped, then it will dry out. Alternatively, if the slice is wrapped then the slice is messy to unwrap. Cake should be eaten with a fork, and even with a fork the cake can be messy for kids to eat. Some schools have banned the bringing of birthday cakes (and cupcakes) to school because of the resulting mess. Accordingly, what is needed is a dessert that uniquely solves the problems of size, portability and messiness while adding other valuable features.

Another shortcoming of the prior art is that often times when baking a cake, the cake will have a crown about the top so that the cake top is not level. The cake is required to be level if preparing a layered cake and to improve the aesthetics of the cake. This top material of the cake is sliced off in chunks until the cake top is level. The remaining cake top can be iced or the cake top is now suitable to receive another cake to form a layered cake. The chunks of cake that are removed are typically thrown away as the chunks are not aesthetically pleasing to serve although the quality and taste of the chunks is not altered and could be consumed. Accordingly, there is a need for a method to be able to reuse the chunks of cake or broken cakes or cookies to prepare a dessert that is aesthetically pleasing and delectable.

Cupcakes have been used in the past to provide a single serving of cake. Specialized pans are made for baking cupcakes, similar in form to muffin tins. These pans are most often made from metal and generally have six or twelve depressions or “cups.” They may also be made from stoneware, silicone rubber, or other materials. A standard size cup is 3 inches in diameter and holds about 4 ounces.

Individual cups, or cupcake liners, may be used in baking. These are typically round sheets of thin paper pressed into a round, fluted cup shape. In addition to paper, cupcake liners may be made from very thin aluminum foil or silicone rubber. Because they can stand up on their own, foil and silicone liners can also be used on a flat baking sheet, which makes them popular among people who do not have a specialized muffin tin. Some of the largest paper liners are not fluted and are made out of thicker paper, often rolled at the top edge for additional strength, so that they can also stand independently for baking without a cupcake tin. Some bakers use two or three thin paper liners nested together to simulate the strength of a single foil cup. The liner is removed to consume the cupcake. Often times this liner is difficult to remove from the cupcake as the liner sticks to the cupcake and damages the aesthetics of the cupcake. Accordingly, a need exists for a dessert and method to make single portions of the dessert that does not damage the aesthetics of the dessert when serving.

### III. SUMMARY

In a particular embodiment, a method of making a dessert is disclosed, the method includes stuffing ingredients of at least one layer of dessert material (for example, cake) and a filling into a container until the container is filled, where the container is adapted to sequentially push out of a top end of the container each of the ingredients for consumption. The method further includes that the layer of dessert material may be trimmed from a portion of a larger baked cake or leftover chunks from leveling the top of the larger cake. In addition, the method may be used with many dessert materials such as cake, brownie, apple pie (or any type pie), ice cream cake, or cheesecake, for example, or any combination thereof.

In another particular embodiment, a method of making a dessert includes stuffing a first layer of dessert material into a bottom of a container, adding a first layer of filling or icing on top of the first layer of dessert material, stuffing a second layer of dessert material on top of the first layer of filling or icing, and adding a second layer of filing or icing on top of the second layer of dessert material, where the container is adapted to push the dessert out of a top end of the container to sequentially reveal each layer of dessert material and layer of filling or icing for consumption. Each layer of dessert material may be formed to approximately a same width as the container before stuffing into the container. The container may be greater in length than in width and may be transparent to view the dessert inside the container.

In another particular embodiment, a dessert is disclosed. The dessert includes at least one alternating layer of dessert material and a filling within a container, where the container is adapted to sequentially push out of a top end of the container the alternating layers of the dessert material and the filling for consumption. The layer of dessert material may be trimmed from a portion of a larger baked cake, for example, or made specifically to fit within the container, or any combination thereof. Each layer of dessert material may be formed to approximately a same width as the container before stuffing into the container. A ratio of the at least one alternating layer of dessert material to the filling may be approximately the same. The filling may be icing, frosting, crème, or any combination thereof. The container may include a plunger for pushing the dessert out of the top end of the container and the container may be transparent. A removable cap may be provided to fit over the top end of the container. In addition, the container may include a guide to evenly direct the plunger through the container when pushing the dessert out of the top end of the container. The container may be greater in length than in width similar to a tube or sleeve or the container may be approximately square in cross sectional shape, which may provide a more efficient design.

Other aspects, advantages, and features of the present disclosure will become apparent after review of the entire application, including the following sections: Brief Description of the Drawings, Detailed Description, and the Claims

### IV. BRIEF DESCRIPTION OF THE DRAWINGS

FIG. 1 is a rear perspective view of a particular illustrative embodiment of a dessert container with the dessert removed;

FIG. 2 is a front perspective view of a particular illustrative embodiment of the dessert container shown in FIG. 1;

FIG. 3 is a front view of the dessert container with the dessert in the container;

FIG. 4 is a front view of the dessert container to demonstrate layers of cake material and filling sequentially pushed out of a top end of the container for consumption;

FIG. 5 is a front view of the dessert container with the remaining layers of cake material and filling;

FIG. 6 is a flow diagram of a particular illustrative embodiment of a method of making a dessert; and

FIG. 7 is a flow diagram of another particular illustrative embodiment of a method of making a dessert with multiple layers.

### V. DETAILED DESCRIPTION

A particular advantage provided by the embodiments of the dessert and method of making same is the ability of a baker to make and sell, and a customer to buy, single servings of any of the desserts, in any desired number. Further, there is an advantage to sell and buy any number of different flavors in any combination at one time and to have single servings of a cake type dessert that are not exposed to the air to dry out. Another particular advantage of the dessert and method of making same described herein is the ability to have single servings of desserts that are easily and safely transportable and to have desserts that can be eaten anywhere without a fork or spoon. In addition, the dessert and method provides a dessert that can be eaten by small children and anyone, with a minimal mess. Another particular advantage is that the cake type dessert can be made by a local bakery, which can ship the cake dessert nationwide, something very difficult to do with normal cake products. The dessert and method of making same provides an attractive and “fun” way to eat cake type desserts and can easily and cheaply create added value to cake type desserts to maximize profits for a bakery. In addition to using ingredients specifically made to be placed in the container, excess cake such as cake tops or broken cakes or cookies, can be utilized to make a salable product with materials that would be normally thrown out.

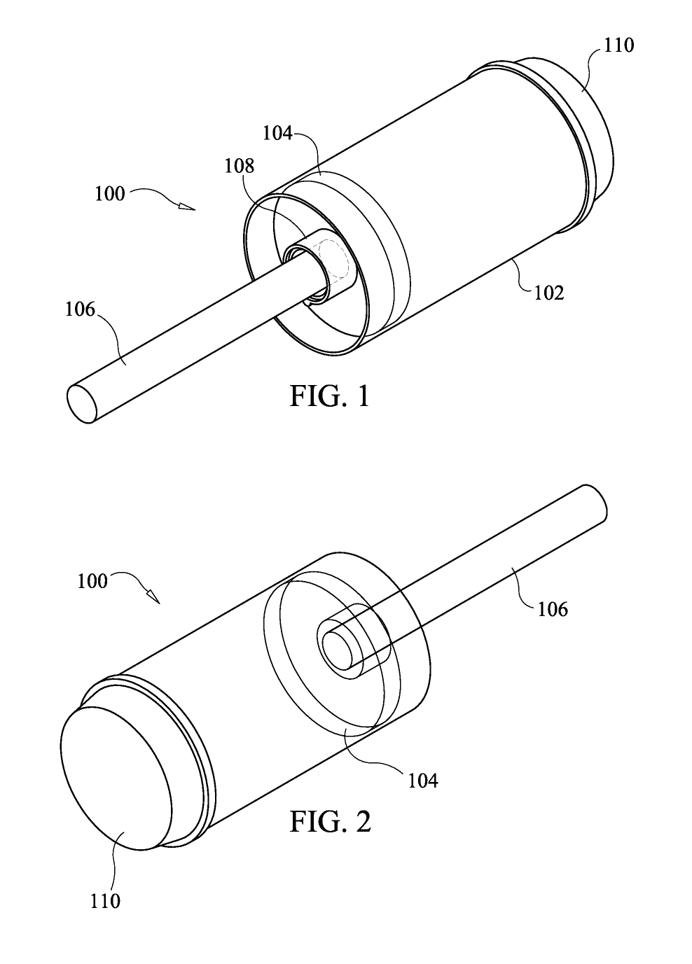

Referring to FIGS. 1 and 2, a particular illustrative embodiment of a cake dessert is disclosed and generally designated 100. A container 102 is used to prepare the dessert. As shown in the FIGS. 1-5, the container 102 may be cylindrical in shape and circular in cross section. However, other shapes and cross sections may be used for the container 102 such as square, star shaped, letter shaped, number shaped, animal shaped, or any number of designs. The container 102 is generally greater in length than in width.

Preferably the container is transparent, translucent, and/or tinted with color to allow visibility of the dessert within the container 102 and to easily identify the contents and type of dessert. In addition, the transparency of the container 102 assists in preparing the dessert as ingredients are loaded into the container 102 as described below. The container 102 may also be opaque.

A plunger 104 is adapted to slide within the container 102 and is used to push the dessert out of a top end of the container 102. A handle 106 is attached to the plunger 104 and is configured to be grasped by the user when pushing the plunger 104. A guide 108 may be used to evenly direct the plunger 104 through the container when pushing the dessert out of the top end of the container 102, thereby assisting in the even distribution of the dessert from the top of the container 102. In this particular embodiment, the guide 108 is an aperture that is centered proximate to a bottom end of the container 102 and is anchored to the periphery of the inside walls of the container 102. The guide 108 keeps the handle 106 centered relative to the container 102 as the handle 106 pushes the plunger 104 towards the top end of the container 102.

The guide may also consist of longitudinal grooves within the walls of the container 102 to allow the plunger 104 to ride within the grooves using protruding extensions. Alternatively, the plunger 104 may have grooves and the walls of the container 102 may have protruding extensions adapted to slide within the grooves. A removable cap 110 may be used to seal the top end of the container 102. Accordingly, the dessert is kept fresh during transport and until consumption.

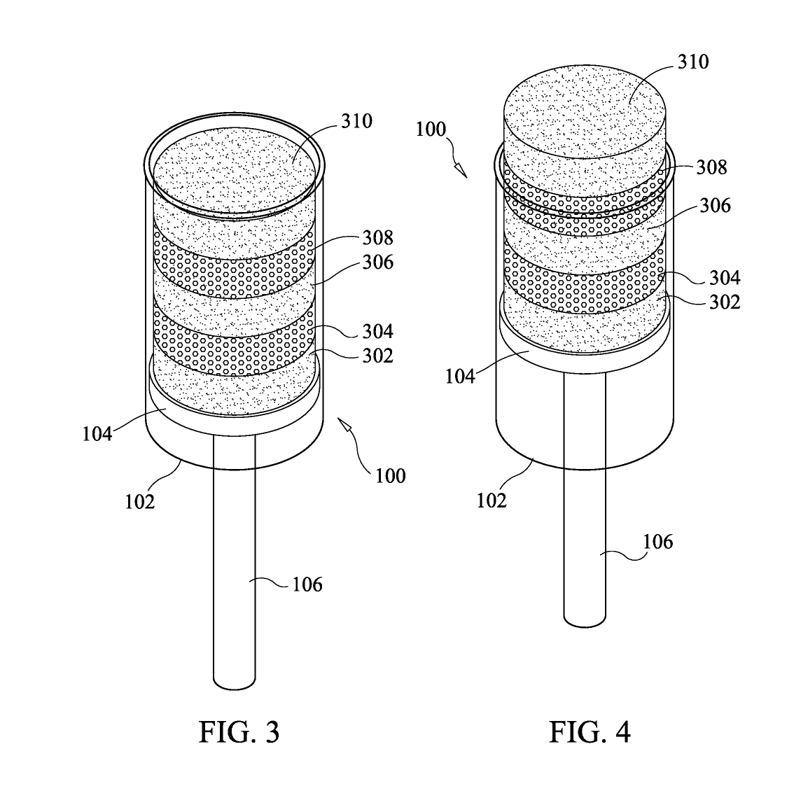

Referring now to FIG. 3, the container 102 is loaded with the dessert ingredients that include alternating layers of cake material and a filling or icing. For example, a first layer of cake material 302 is stuffed into the bottom of the container 102. The first layer of cake material 302 rests on the plunger 104. A first layer of filling or icing 304 is added on top of the first layer of cake material 302. A second layer of cake material 306 is stuffed on top of the first layer of filling or icing 304. A second layer of filling or icing 308 is added on top of the second layer of cake material 306. In this example, a third layer of cake material 310 is stuffed on top of the second layer of icing 308. The ingredients are alternated as they are stuffed and added to the container 102 until the container 102 is full. There may be any number of layers of filling and icing and layers of cake material. In addition, the dessert may begin with adding filling or icing at the bottom of the container 102 instead of beginning with a layer of cake material, or any combination thereof.

In addition, there are many cake type desserts and other types of desserts that may be used with the container 102. For example, ice cream cakes, brownies, cheesecakes, trifles, rum cakes, fruit cakes, truffles, pies, bread pudding, etc. Even refrigerator cakes that are made by alternating layers of cookies or cookie pieces with whipped topping and refrigerated, rather than baked, are a form of cake type dessert. Further, there may be any number of layers and variations of ingredients. The method of placing the ingredients inside the container 102 depends on product, consistency, temperature of the product, and the degree of automation used.

The layers of cake material 302, 206, 310 may be trimmed from a portion of a top of a larger baked cake that has been leveled or the layer of cake may be trimmed using a cookie cutter or the container itself 102 to cut the layer from a larger cake, or any combination thereof. The cake material may also be specially baked for the container 102 or be ice cream cake material or a type of unbaked cake material, for example. The layers of cake material are formed to approximately the same width as the container 102 before stuffing into the container 102. The ratio (i.e., thickness) of the layer of cake material to the filling may be approximately the same as the container 102 is filled. In a particular embodiment, a finished dessert (e.g., layered cake) may be prepared to be approximately a thickness of the container's 102 length. A cutter or the container 102 itself may be pressed into the dessert layers contemporaneously to trim a portion to fit inside the container 102 instead of stuffing the layers separately into the container 102.

The dessert is pushed out of the top end of the container 102 as illustrated in FIG. 4. When the handle 106 is pushed, the handle forces the plunger 104 to move towards the top of the container 102 and to sequentially push out of the top end of the container 102 the alternating layers of the cake material and the filling (or icing) for consumption. The filling or icing may be cream cheese filling, vanilla Bavarian cream, pineapple filling, coconut filling, raspberry swirl, chocolate butter cream icing, for example.

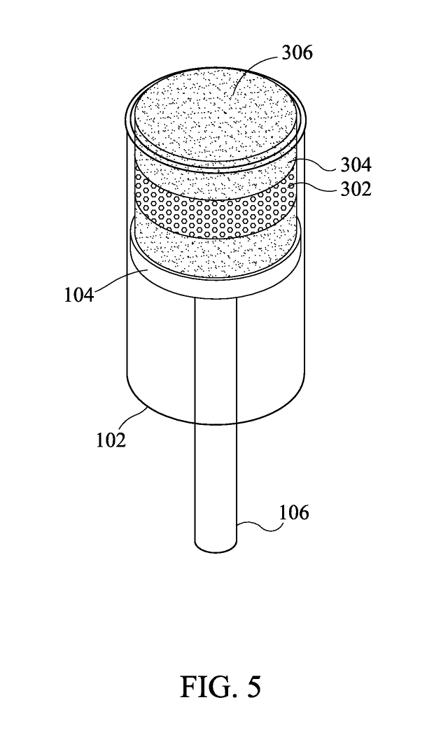

In this example, the first layer pushed out of the container 102 is the third layer of cake material 310 as shown in FIG. 4. As the alternating layers of cake material and filling are sequentially pushed out of the top end of the container 102, the dessert may be consumed as the ingredients become accessible as illustrated in FIG. 5, where the second layer of filling or icing 308 and the third layer of cake material 310 have been consumed.

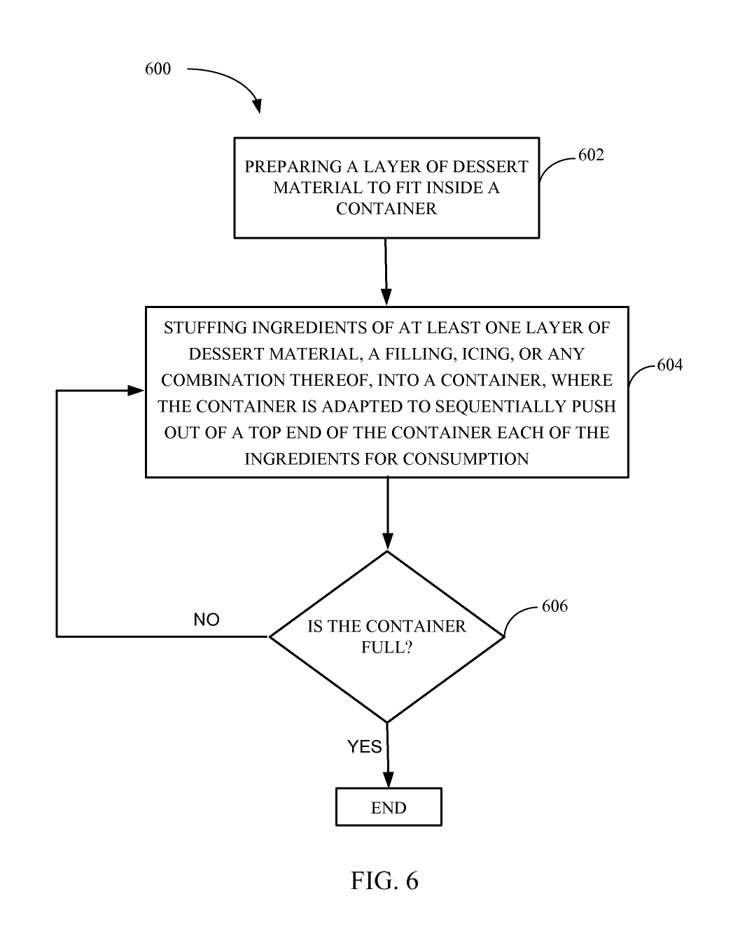

Referring to FIG. 6, a particular illustrative embodiment of a method of preparing a dessert is disclosed and generally designated 600. The method includes preparing a layer of dessert material to stuff inside a container, at 602. Moving to 604, ingredients of at least one layer of dessert material, a filling or icing, or any combination thereof, are stuffed into a container to form alternating layers within the container. This step is repeated until the container is full, at 606. Once the container is full, the method includes sequentially pushing out of a top end of the container each of the ingredients for consumption, at 608. Alternatively, the container may be filled with a single ingredient instead of alternating layers, or any combination of ingredients in any order. Also, as described, a finished dessert (e.g., layered cake) may be prepared to be approximately a thickness of the container's length. A cutter or the container itself may be pressed into the at least one dessert layer contemporaneously to trim a portion to fit inside the container instead of stuffing the layers separately into the container.

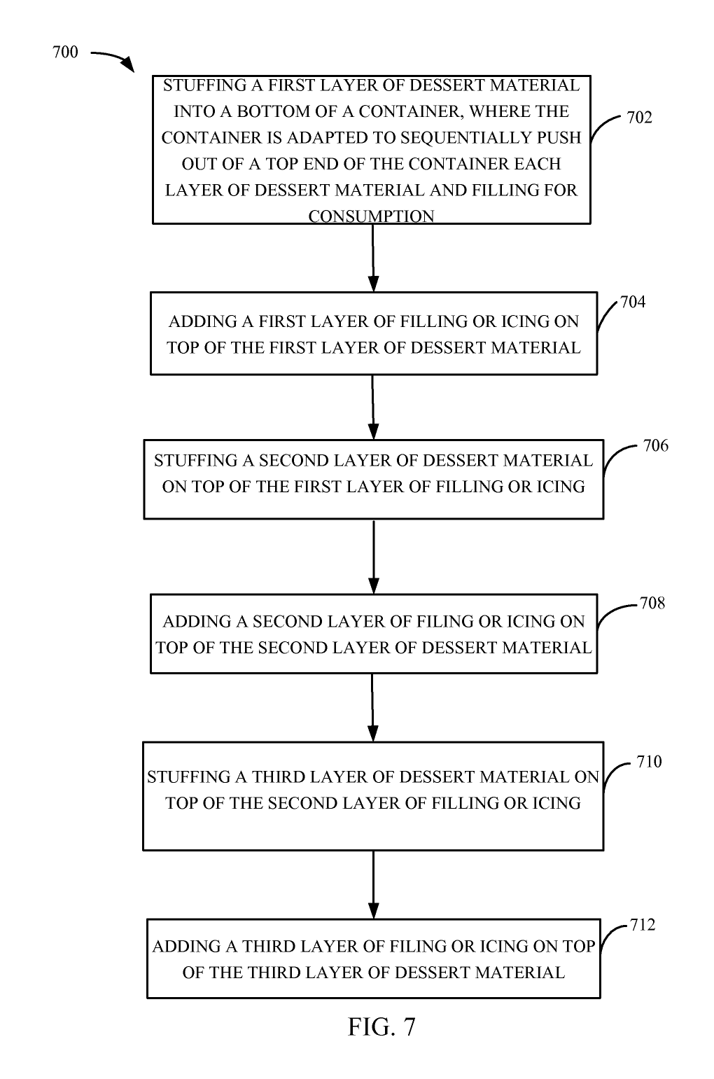

Another particular illustrative embodiment of a method of preparing a dessert is disclosed and generally designated 700, as illustrated in FIG. 7. The method includes stuffing a first layer of cake material into a bottom of a container, at 702. Continuing to 704, a first layer of filling or icing is added on top of the first layer of cake material. A second layer of cake material, at 706, is stuffed on top of the first layer of filling or icing. A second layer of filling or icing is added on top of the second layer of cake material, at 708. A third layer of cake material, at 710 is stuffed on top of the second layer of filling or icing and a third layer of filling or icing is added on top of the third layer of cake material, at 712, to fill the container. As described above, the method may alternatively include filling the container with a single dessert ingredient or any combination of different dessert ingredients and filling in any order.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

1. A method of preparing a dessert, the method comprising:
stuffing ingredients of alternating layers of dessert material, a filling, or any combination thereof, into a bottom of a container until the container is filled, wherein a slidable plunger of the container is adapted to sequentially push out of a top end of the container each of the alternating layers for consumption directly from the container.

2. The method of claim 1, further comprising providing the layer of dessert material trimmed from a portion of a larger cake or specifically baked to fit within the container, or any combination thereof.

3. A method of preparing a dessert, the method comprising:
stuffing a first layer of dessert material into a bottom of a container;
adding a first layer of filling or icing on top of the first layer of dessert material;
stuffing a second layer of dessert material on top of the first layer of filling or icing; and
adding a second layer of filling or icing on top of the second layer of dessert material;
wherein a slidable plunger of the container is adapted to push the dessert out of a top end of the container to sequentially reveal each layer of dessert material and layer of filling or icing for consumption directly from the container.

4. The method of claim 3, wherein each layer of dessert material is formed to approximately a same width as the container before stuffing into the container.

5. The method of claim 4, wherein the container is greater in length than in width.

6. The method of claim 5, wherein the container is transparent to view the dessert inside the container.

7. The method of claim 6, wherein the dessert material is cake, brownie, apple pie, cheesecake, ice cream, bread pudding, or any combination thereof.

8. A dessert, the dessert comprising:
a container;
a plunger adapted to slide within the container from a bottom end to a top end of the container, wherein a periphery of the plunger maintains contact with an interior surface of the container; and
alternating layers of dessert material, a filling, or any combination thereof, stuffed into the container, wherein the plunger is adapted to sequentially push out of the top end of the container each of the alternating layers for consumption directly from the container.

9. The dessert of claim 8, wherein the layer of dessert material is trimmed from a portion of a larger baked cake.

10. The dessert of claim 8, wherein the dessert material is cake, brownie, apple pie, cheesecake, ice cream, bread pudding, or any combination thereof.

11. The dessert of claim 8, wherein each layer of dessert material is formed to approximately a same width as the container before stuffing into the container.

12. The dessert of claim 8, wherein a ratio of the at least one layer of dessert material to a filling is approximately the same.

13. The dessert of claim 8, wherein the filling is cream cheese filling, vanilla Bavarian cream, pineapple filling, coconut filling, raspberry swirl, chocolate butter cream icing, or any combination thereof.

14. (canceled)

15. The dessert of claim 8, wherein the container is transparent.

16. The dessert of claim 8, further comprising a removable cap to fit over the top end of the container.

17. The dessert of claim 8, further comprising a guide aperture to guide a handle of the plunger, wherein the guide is proximate to a bottom end of the container and anchored to the interior surface of the container to evenly direct the plunger through the container when pushing the dessert out of the top end of the container.

18. The dessert of claim 8, wherein the container is greater in length than in width.

19. The dessert of claim 8, wherein there are three alternating layers of the dessert material and the filling inside the container.

20. The dessert of claim 8, wherein the container is cylindrical or square in cross sectional shape.
